(19) United States
(12) Patent Application Publication
(10) Pub. No.: US 2012/0118115 A1
(43) Pub. Date: May 17, 2012

(54) DUAL-PURPOSE PLIERS FOR CONNECTING AND DISCONNECTING A MASTER LINK OF A CHAIN

(76) Inventor: Chun-Wei HUANG, Chang Hwa (TW)

(21) Appl. No.: 12/945,867

(22) Filed: Nov. 14, 2010

(51) Int. Cl. B25B 7/02; B25B 27/22

(52) U.S. Cl. 81/308

(57) ABSTRACT

A pair of dual-purpose pliers for connecting and disconnecting a master link of a chain comprises a single jaw handle and a double-jaw handle. The single jaw handle is formed with a grip at a first end thereof and a single jaw at a second end thereof. The double jaw handle is formed with a grip at a first end thereof and a left jaw and a right jaw at a second end thereof. After the single jaw handle and the double jaw handle are pivotally connected, the single jaw is located between the left and the right jaws, a groove of the single jaw and a groove of the left jaw are arranged in a face-to-face manner, and the groove of the single jaw and a groove of the right jaw are arranged in back-to-back manner.

### BACKGROUND OF THE INVENTION

1. Field of the Invention

The present invention relates to a pair of pliers, and more particularly to a pair of dual-purpose pliers for connecting and disconnecting a master link of a chain.

2. Description of the Prior Art

Referring to FIG. 1, a pair of conventional expanding pliers 10 for connecting/disconnecting a master link of a chain comprises two clamping jaws 11 each of which is formed with a concave arc 12 at an outer side thereof. A chain 13 with a master link consists of a plurality of fixed plates 14 and rivets 15 that are connected together. The master link includes a movable plate 16 which is connected to the fixed plates 14 through the rivets 15. The movable plate 16 is formed with a profiled hole 161 for enabling the movable plate 16 to be connected to or disconnected from the rivet 15.

When assembling the movable plate 16 of the chain 13, the respective concave arcs 12 of the two clamping jaws 11 are pressed against the respective rivets 15 at both sides of the movable plate 16, and then the two clamping jaws 11 are expanded outward by pressing the expanding pliers 10 so as to pull the rivet 15 within the profiled hole 161 of the movable plate 16 into a connecting position.

And when disassembling the movable plate 16 from the chain 13, a pair of conventional pressing pliers, such as nipper pliers, will be used to press the rivet into a disconnecting position, disassembling the movable plate (not shown).

As known from the above description, the assembling and disassembling operations of the master chain of the bicycle chain require the use of two different pliers: the expanding pliers and the pressing pliers, which are not only inconvenient to carry but also cause unnecessary cost.

The present invention has arisen to mitigate and/or obviate the afore-described disadvantages.

### SUMMARY OF THE INVENTION

The primary objective of the present invention is to provide a pair of dual-purpose pliers for connecting and disconnecting a master link of a chain, the pair of dual-purpose pliers for connecting and disconnecting a master link of a chain comprises a single jaw handle and a double jaw handle. The single jaw handle is formed with a grip at a first end thereof and a single jaw at a second end thereof. The single jaw includes a jaw hook at an end thereof opposite to the grip of the single jaw handle, and the jaw hook of the single jaw is formed with a groove at a left side thereof. The double jaw handle is formed with a grip at a first end thereof and a left jaw and a right jaw at a second end thereof. The left jaw includes a jaw hook at an end thereof opposite to the grip of the double-jaw handle, and the jaw hook of the left jaw is formed with a groove at a right side thereof. The right jaw includes a jaw hook at an end thereof opposite to the grip of the double-jaw handle, and the jaw hook of the right jaw is formed with a groove at a right side thereof. The double jaw handle is pivotally connected to the single jaw handle by a pivot pin in such a manner the two grips of the single jaw handle and the double jaw handle are cross connected, and the single jaw is located between the left and the right jaws. The groove of the jaw hook of the single jaw and the groove of the jaw hook of the left jaw are arranged in a face-to-face manner while the groove of the jaw hook of the single jaw and the groove of the jaw hook of the right jaw are arranged in back-to-back manner.

By such arrangements, the pliers of the present invention can not only perform the expanding operation with the single jaw and the right jaw but perform the pressing operation with the single jaw and the left jaw, thus connecting and disconnecting the master link.

### BRIEF DESCRIPTION OF THE DRAWINGS

FIG. 1 is an operational view of a pair of conventional expanding pliers for a bicycle chain;

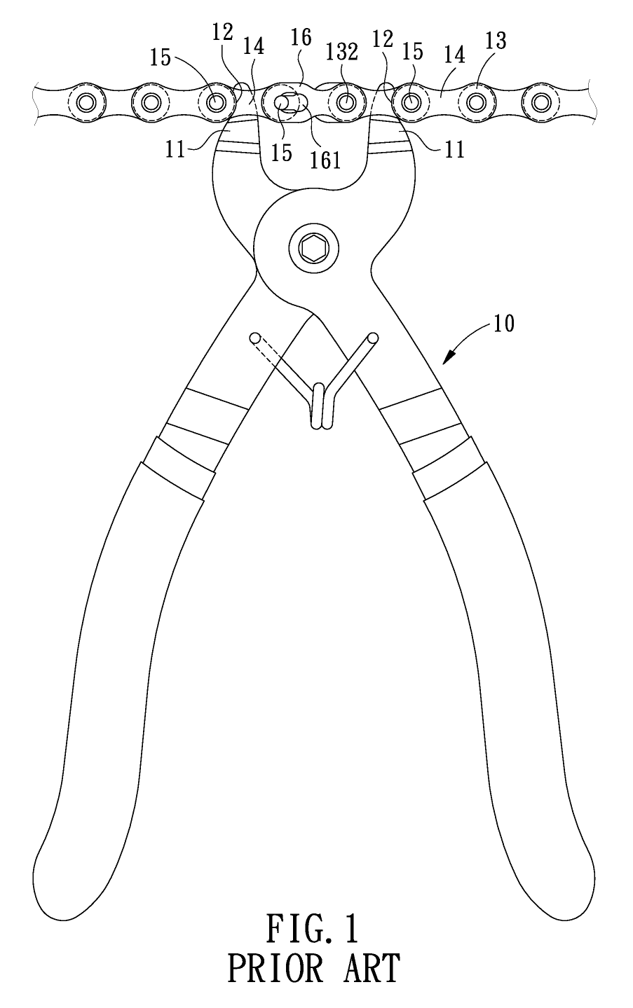

FIG. 2 is an exploded view of a pair of dual-purpose pliers in accordance with the present invention;

FIG. 3 is a combinational view of the pair of dual-purpose pliers in accordance with the present invention;

FIG. 4 is a schematic view showing that the pair of dual-purpose pliers in accordance with the present invention is ready for connecting the movable plate;

FIG. 5 is a schematic view showing that the pair of dual-purpose pliers in accordance with the present invention has finishing the operation of connecting the movable plate;

FIG. 6 is a schematic view showing that the pair of dual-purpose pliers in accordance with the present invention is ready for disconnecting the movable plate;

FIG. 7 is a schematic view showing that the pair of dual-purpose pliers in accordance with the present invention has finishing the operation of disconnecting the movable plate; and

FIG. 8 is a perspective view showing that a spring is disposed between the two grips of the dual-purpose pliers in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

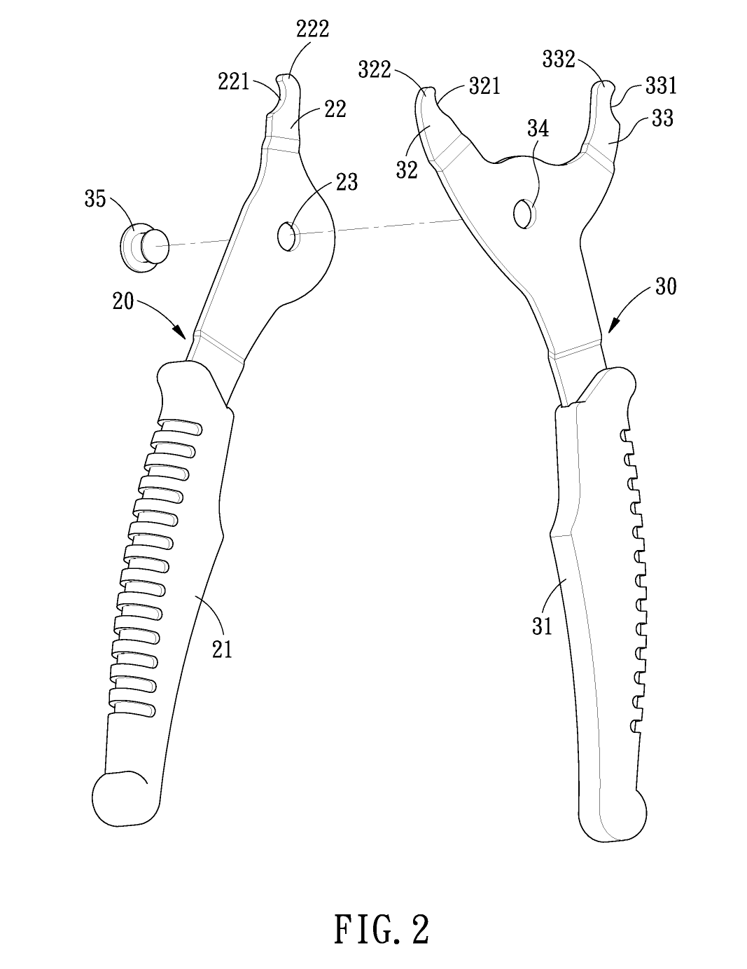

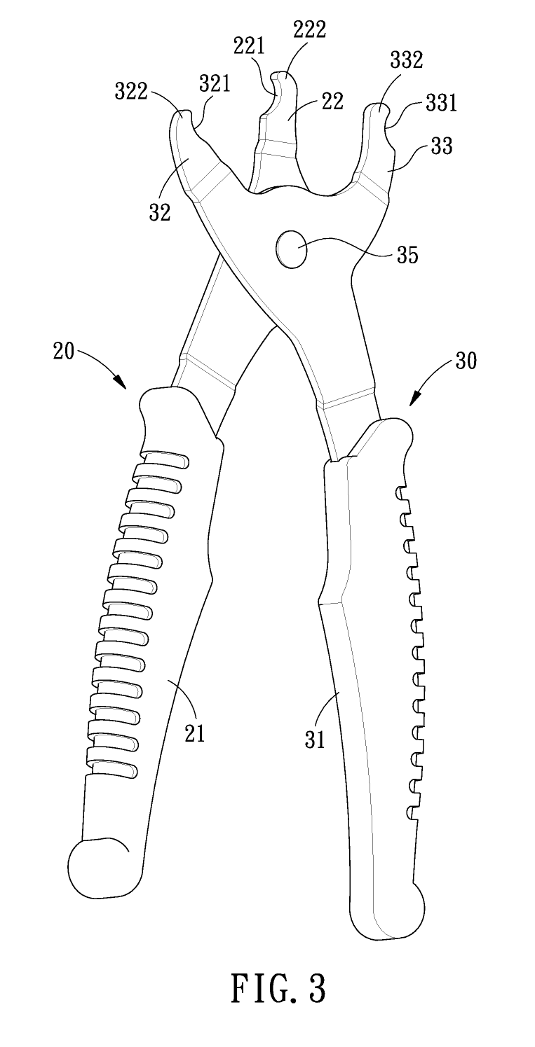

Referring to FIGS. 2-4, a pair of dual-purpose pliers for connecting and disconnecting a master link of a chain in accordance with the present invention comprises a single jaw handle 20 and a double jaw handle 30 that are pivotally connected.

The single-jaw handle 20 is formed with a grip 21 at a first end thereof, and a single jaw 22 at a second end thereof. The single jaw 22 includes a jaw hook 222 at an end thereof opposite to the grip 21, and the jaw hook 222 is formed with a groove 221 at a left side thereof. The single jaw handle 20 is further formed with a pivot hole 23.

The double jaw handle 30 is formed with a grip 31 at a first end thereof, and two jaws at a second end thereof. The two jaws are a left jaw 32 and a right jaw 33. The left jaw 32 includes a jaw hook 322 at an end thereof opposite to the grip 31, and the jaw hook 322 is formed with a groove 331 at a right side thereof. The right jaw 33 includes a jaw hook 332 at an end thereof opposite to the grip 31, and the jaw hook 332 is formed with a groove at a right side thereof. The double-jaw handle 30 is further formed with pivot hole 34. The double-jaw handle 30 is pivotally connected to the single jaw handle 20 by inserting a pivot pin 35 through the two pivot holes 23, 34 in such a manner that the two grips 21, 31 of the single jaw handle 20 and the double jaw handle 30 are cross connected. The single jaw 22 is located between left and the right jaws 32, 33. The groove 221 of the jaw hook 222 of the single jaw 22 and the groove 321 of the jaw hook 322 of the left jaw 32 are arranged in a face-to-face manner while the groove 221 of the jaw hook 222 of the single jaw 22 and the groove 331 of the jaw hook 332 of the right jaw 33 are arranged in a back-to-back manner.

The aforementioned is the summary of the positional and structural relationship of the respective components of the preferred embodiment in accordance with the present invention.

For a better understanding of the present invention, its operation and function, reference should be made to FIGS. 2-4:

The double-purpose pliers in accordance with the present invention can perform both the pressing and the expanding operations to connect and disconnect the master link of a chain easily. The chain 40 is formed by connecting plural fixed plates 41 and rivets 42. The master link of a chain includes a movable plate 43 connected to one fixed plate 41 through rivet 42. The movable link 43 includes a profiled hole 431 for enabling the movable plate 43 to be connected to or disconnected from the rivet 42.

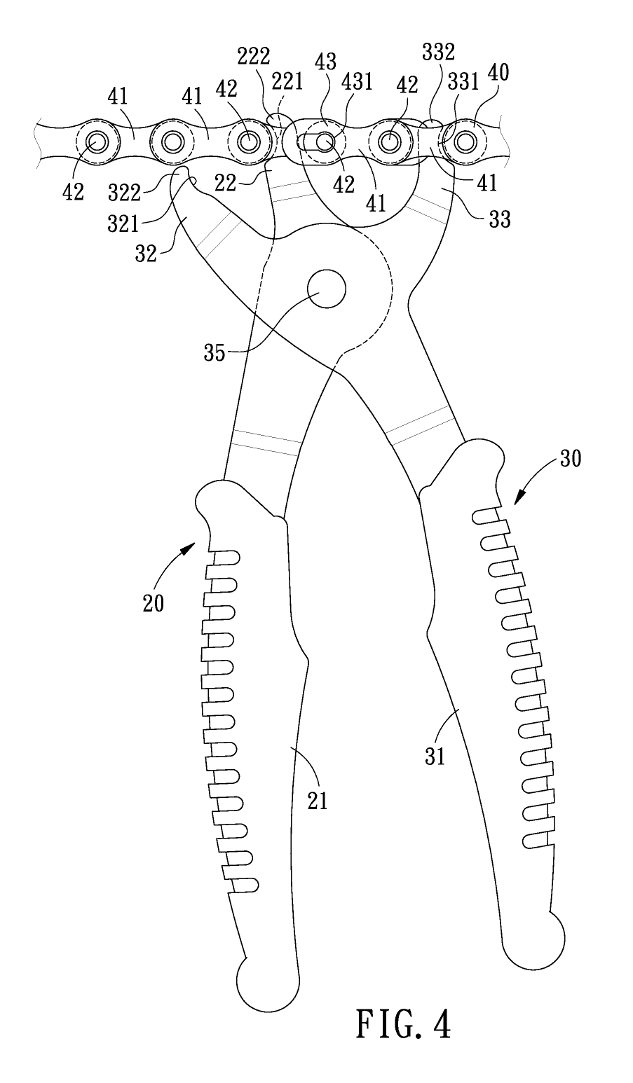

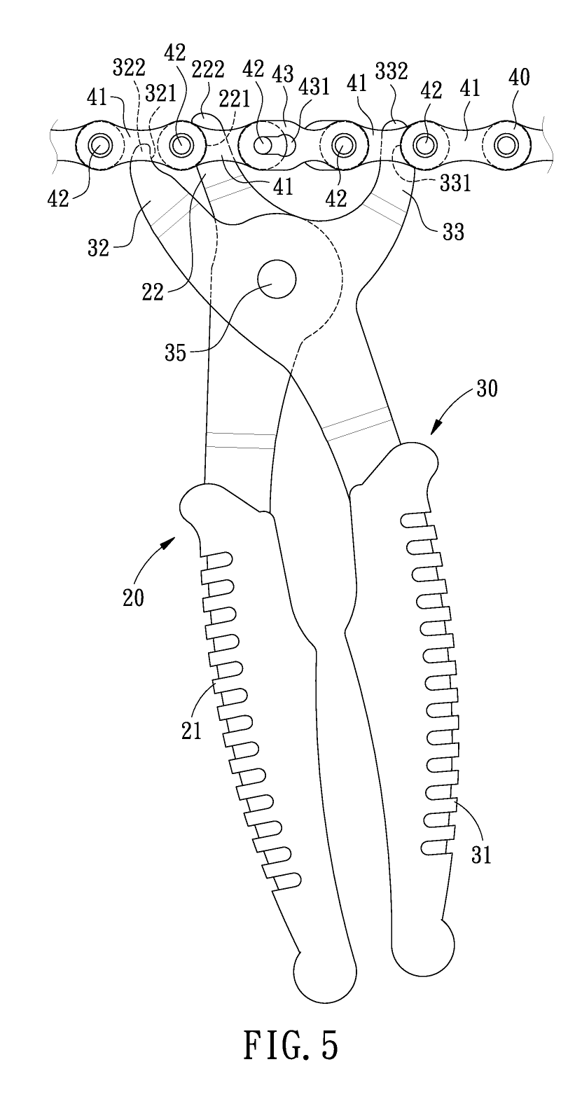

As shown in FIG. 4, to assemble the movable plate 43 of the chain 40, the user can put the jaw hook 332 of the right jaw 33 and the jaw hook 222 of the single jaw 22 of the dual-purpose pliers against the rivets 42 at both sides of the movable plate 43, respectively, and then, as shown in FIG. 5, press the two grips 21, 31 of the dual-purpose pliers to open the left jaw 33 and the single jaw 22, thus moving the movable plate 43 into a locked position with respect to the rivet 42.

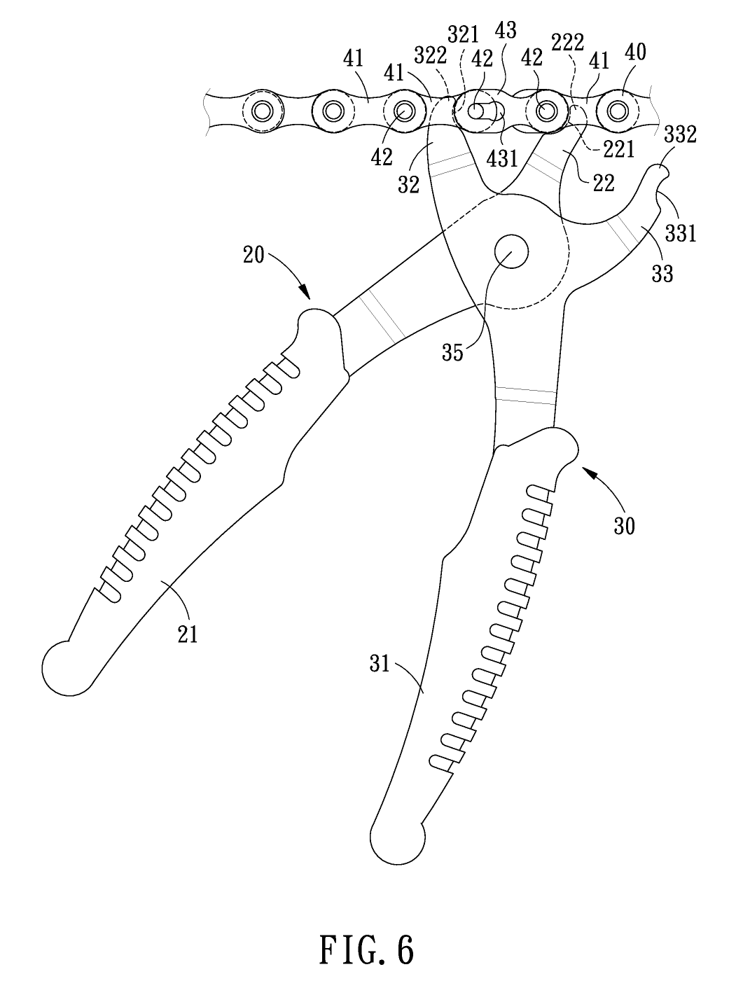

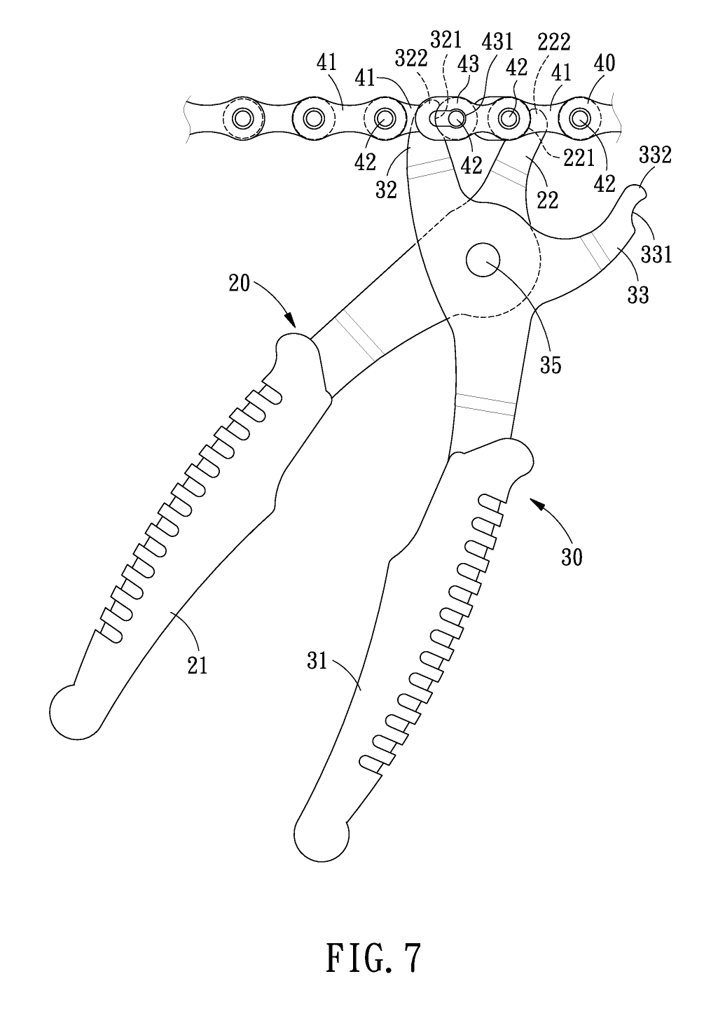

As shown in FIG. 6, to disassemble the movable plate 43 of the chain 40, the user can put the jaw hook 322 of the left jaw 32 of the dual-purpose pliers and the jaw hook 222 of the single jaw 22 against the rivets 42 at both sides of the movable plate 43, respectively, and then, as shown in FIG. 7, press the two grips 21, 31 of the dual-purpose pliers to close the right jaw 32 and the single jaw 22, thus moving the movable plate 43 into a unlocked position with respect to the rivet 42.

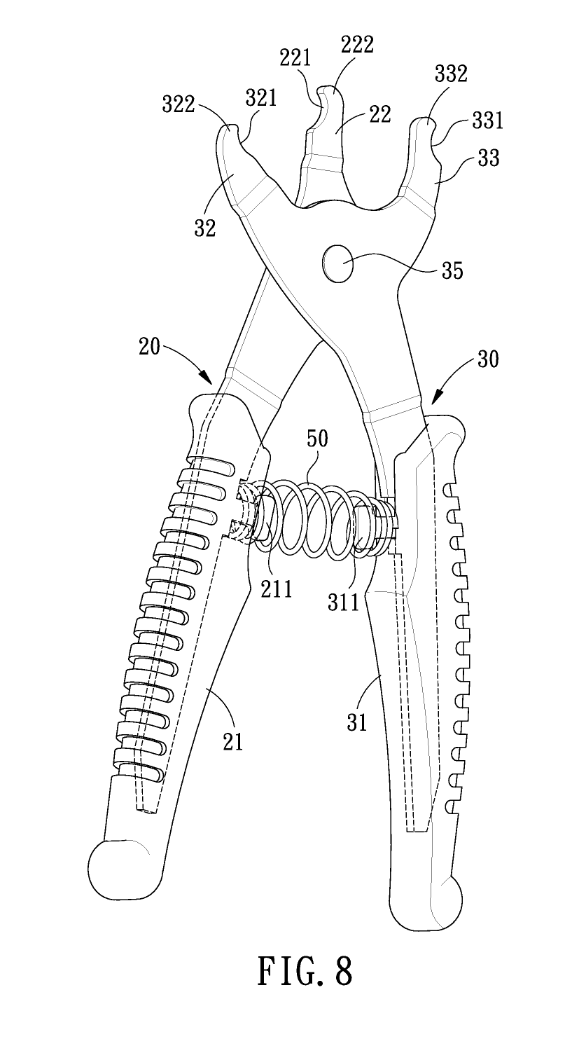

Additionally referring to FIG. 8, the two grips 21, 31 of the present invention each are further formed with an engaging protrusion 211, 311. A spring 50 is biased between the two engaging protrusions 211, 311, so that after the two grips 21, 31 of the dual-purpose pliers are pressed, the spring 50 will provide an elastic restoring force to the two grips 21, 31, making the two grips 21, 31 restore to their original positions.

It is to be noted that, the structure of the present invention is quite simplified but perform two operations different in working directions. Especially, the design of the single jaw is the most difficult. In the present invention, being only formed with a groove at one side, the single jaw can cooperate with the right jaw to perform the expanding operation or cooperate with the left jaw to perform the pressing operation.

While we have shown and described various embodiments in accordance with the present invention, it is clear to those skilled in the art that further embodiments may be made without departing from the scope of the present invention.

What is claimed is:

1. A pair of dual-purpose pliers for connecting and disconnecting a master link of a chain, comprising:
a single-jaw handle being formed with a grip at a first end thereof and a single jaw at a second end thereof, the single jaw including a jaw hook at an end thereof opposite to the grip of the single-jaw handle, the jaw hook of the single jaw being formed with a groove at a left side thereof; and
a double jaw handle being formed with a grip at a first end thereof and a left jaw and a right jaw at a second end thereof, the left jaw including a jaw hook at an end thereof opposite to the grip of the double jaw handle, the jaw hook of the left jaw being formed with a groove at a right side thereof, the right jaw including a jaw hook at an end thereof opposite to the grip of the double jaw handle, the jaw hook of the right jaw being formed with a groove at a right side thereof, the double jaw handle being pivotally connected to the single jaw handle by a pivot pin in such a manner the two grips of the single-jaw handle and the double-jaw handle are cross connected, the single jaw being located between the left and the right jaws, the groove of the jaw hook of the single jaw and the groove of the jaw hook of the left jaw being arranged in a face-to-face manner while the groove of the jaw hook of the single jaw and the groove of the jaw hook of the right jaw are arranged in back-to-back manner.

2. The pair of dual-purpose pliers for connecting and disconnecting a master link of a chain as claimed in claim 1, wherein the two grips each are formed with an engaging protrusion, and a spring is biased between the two engaging protrusions to provide an elastic restoring force to the two grips.
